(19) United States
(12) Patent Application Publication
(10) Pub. No.: US 2016/0229478 A1
(43) Pub. Date: Aug. 11, 2016

(54) LONGITUDINAL MOUNTED FRONT ENGINE, SEAT STRADDLE REVERSE TRIKE MOTORCYCLE

(71) Applicant: Scott Stephani, Oneida, WI (US)

(72) Inventor: Scott Stephani, Oneida, WI (US)

(21) Appl. No.: 14/617,083

(22) Filed: Feb. 9, 2015

(51) Int. Cl. B62K 5/05; B62K 5/027; B62K 5/08

(52) U.S. Cl. CPC B62K 5/05; B62K 5/08; B62K 5/027

(57) ABSTRACT

A three wheeled, reverse trike motorcycle design includes a front-mounted engine. With the engine mounted between the front two wheels, heat from the engine does not rise up to the bike riders. In addition, with the engine mounted at the front of the bike, the area where the gas tank and engine would normally be on a typical motorcycle has been opened up, making getting on and off easier, especially for older riders. This engine mounted design also provides space for a rider to move their feet and legs around during a ride, increasing circulation, making long trips much more comfortable. The reverse trike motorcycle design includes a straddle seat, adaptable for one or more riders, providing the rider with a conventional motorcycle ride, while providing the safety and comfort of a reverse trike design.

### BACKGROUND OF THE INVENTION

The present invention relates to motorcycles and, more particularly, to a reverse trike style motorcycle having a straddle seat and a longitudinal mounted front engine.

In an effort to reduce cost of operation, it has been desirable to reduce the fuel consumption of automotive vehicles that include an internal combustion engine. Accordingly, the size and power of some known vehicles are being reduced to improve the fuel efficiency of the engines included therein. Moreover, internal combustion engines themselves are becoming ever more fuel efficient. Such advances in efficiency, however, are limited, and can contribute to an increased interest in alternatives to traditional four-wheeled automobiles.

One such alternative to traditional four-wheeled vehicles is a motorcycle. Large touring bikes, however, are heavy and difficult to hold upright while not in motion, especially with a passenger or if the road surface is covered by rocks, sand, or is hot and slippery.

The goal of combining the desirable features of both four-wheeled vehicles and motorcycles has led to the development of three-wheeled vehicles. Tricycles and motorized versions thereof have been available for well over a hundred years. Typically, motorized tricycles take one of two forms: a delta, configured with a single front wheel and a pair of rear wheels; or a tadpole, configured with a pair of front wheels and a single rear wheel. The delta form is often referred to as a trike, while the tadpole version is referred to as a reverse trike. Both the trike and the reverse trike use a variety of configurations of engines, transmissions, suspension, and rider seating, among others.

Known reverse trikes commonly have very limited space to accommodate components thereof due to their reduced width at the back end. Therefore, the vehicle components, such as the engine and/or fuel tank, cannot be arranged in the same manner as either motorcycles or four-wheeled vehicles.

Some known three-wheeled vehicles include a straddle seating arrangement, similar to the seating arrangement of a motorcycle. This seating arrangement allows for the reduced width of the back end portion of the vehicle, at least in part, by accommodating certain drive train components, such as the engine and/or fuel tank, partially or completely under the seat. In some known straddle-style three-wheeled vehicles, the operational controls of the vehicle (e.g., throttle control, brake control, clutch control, etc.) are arranged at least in part on the handle bars, similarly to those found in motorcycles.

Other known three-wheeled vehicles include an enclosed seating area and can further include a recumbent seating arrangement that is similar to those found in four-wheeled vehicles. In some such vehicles, the operational controls of the vehicle can be similar to those commonly found in four-wheeled automobiles. For example, some such vehicles can include a steering wheel and a foot pedal arrangement of the throttle control, the brake, and/or the clutch. The configuration of such vehicles, however, can often result in a further reduction of space with which vehicle components can be located. For example, in some known reverse-trikes, the fuel tank is located below a portion of the seating area, thereby limiting possible seating arrangements. More specifically, the placement of the fuel tank below the recumbent seat can limit and/or prevent the implementation of an adjustable seating arrangement because of limitations in space and mounting locations. Accordingly, the seats included in such instances can be substantially less ergonomic and/or comfortable.

Traditional touring bikes utilize air cooled engines mounted under the rider. The heat rises up, directly across the rider, making hot days almost unbearable, especially in start and stop riding, such as city driving. With the engine mounted under the rider, there can be difficulty in getting on and off the motorcycle. Finally, the engine and gas tank take up substantial space where the riders legs go, making it difficult to move and reposition one's legs while riding.

As can be seen, there is a need for a reverse trike that overcomes the issues and inconveniences found in traditional motorcycles and reverse trikes on the road today.

### SUMMARY OF THE INVENTION

In one aspect of the present invention, a reverse trike motorcycle comprises a rear wheel; first and second front wheels; an engine disposed between the first and second front wheels; and a straddle-style seat disposed between the rear wheel and the first and second front wheels.

In another aspect of the present invention, a reverse trike motorcycle comprises a rear wheel; first and second front wheels; an engine disposed forward of a steering column of the reverse trike motorcycle; and a straddle-style seat disposed between the rear wheel and the first and second front wheels.

In a further aspect of the present invention, a reverse trike motorcycle comprises a rear wheel; first and second front wheels; a longitudinal mounted front engine disposed between the first and second front wheels; a space is disposed between the seat and a steering column of the motorcycle; and a straddle-style seat disposed between the rear wheel and the first and second front wheels.

These and other features, aspects and advantages of the present invention will become better understood with reference to the following drawings, description and claims.

### BRIEF DESCRIPTION OF THE DRAWINGS

FIG. 1 is a side view of a reverse trike motorcycle according to an exemplary embodiment of the present invention; and

FIG. 2 is a front view of the reverse trike motorcycle of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a three wheeled, reverse trike motorcycle design with a front-mounted engine. With the engine mounted between the front two wheels, heat from the engine does not rise up to the bike riders. In addition, with the engine mounted at the front of the bike, the area where the gas tank and engine would normally be on a typical motorcycle has been opened up, making getting on and off easier, especially for older riders.

This engine mounted design also provides space for a rider to move their feet and legs around during a ride, increasing circulation, making long trips much more comfortable. The reverse trike motorcycle design includes a straddle seat, adaptable for one or more riders, providing the rider with a conventional motorcycle ride, while providing the safety and comfort of a reverse trike design.

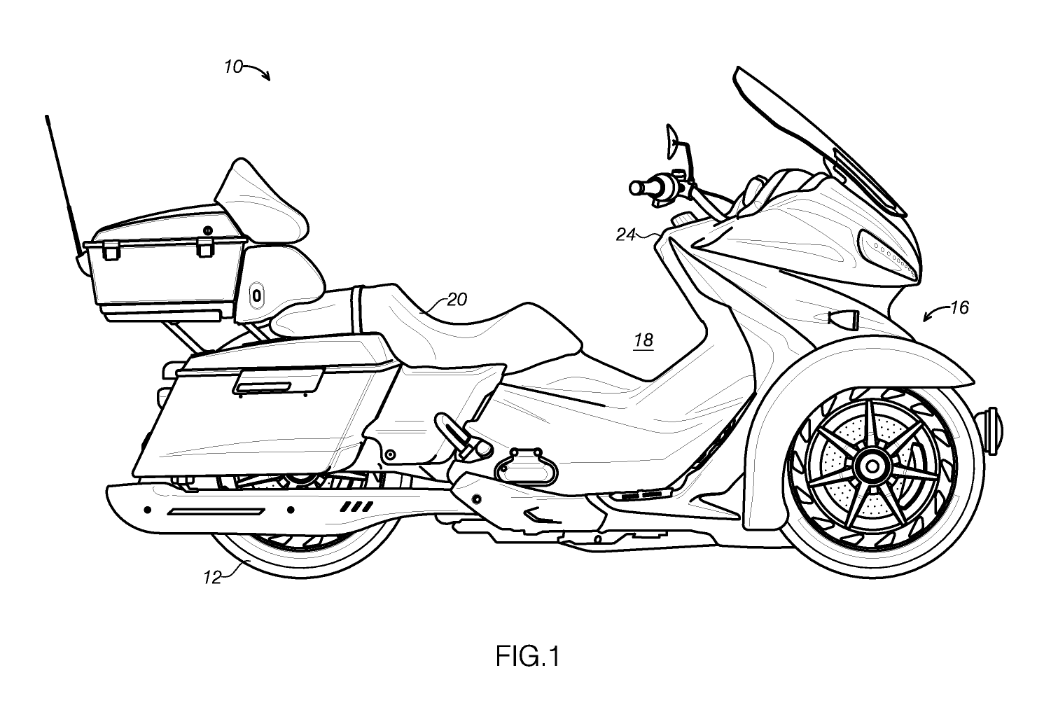

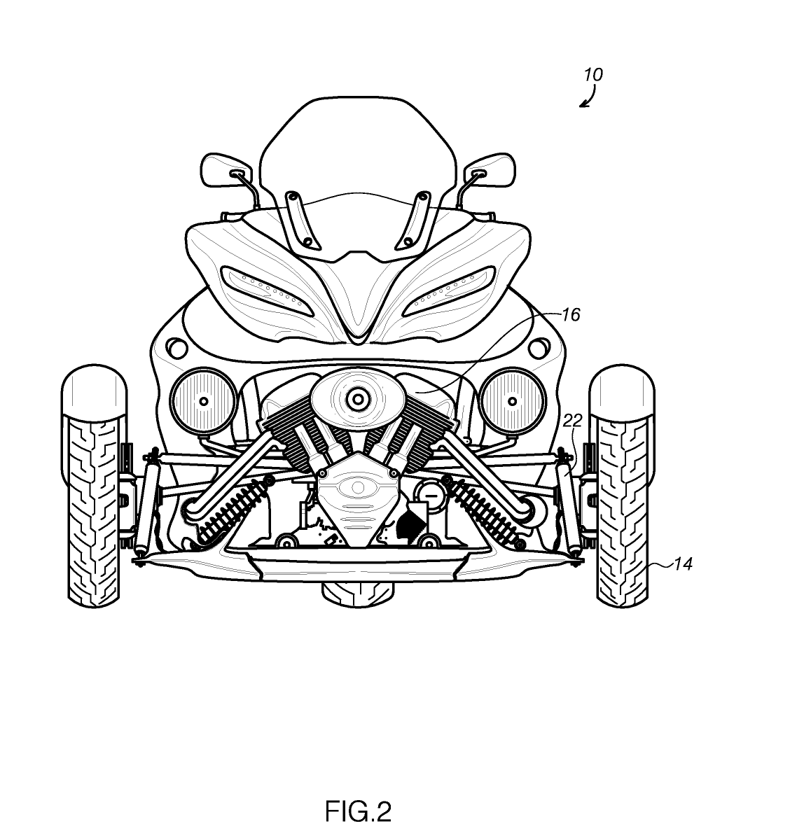

Referring now to FIGS. 1 and 2, a motorcycle 10 can be designed as a reverse trike, having a single rear wheel 12 and two front wheels 14, the front wheels spaced apart a distance suitable for an engine 16 to be mounted therebetween. The engine 16 may be, for example, a longitudinal mounted front engine. The engine 16 may be, for example, mounted forward of a steering column 24 of the motorcycle 10. In other words, the engine 16 may be mounted, location-wise, similar to that of a car, but in the compact design of a reverse trike motorcycle.

With the engine 16 moved forward from its traditional mounting location, a space 18 may be provided where the engine 16 would conventionally be located. The space 18 may be disposed between a seat 20 and a steering column 24 of the motorcycle 10. The space 18 may be useful to permit the rider to move their feet and legs more freely, making for a comfortable ride. This space 18 also makes it easier for a rider to get on and off the motorcycle 10.

The seat 20 can be disposed on the motorcycle 10 typically above and forward of the rear wheel 12. The seat 20 can be a straddle style seat as conventionally used in motorcycles. The seat 20 may be designed for a single rider, or may be designed for multiple riders, such as two riders, as illustrated in FIG. 1.

The engine 16 may be mechanically attached to a shaft 22 of the wheels 12, 14. The connection between the engine 16 and the wheels 12, 14 may be similar to that known in the art and may include intermediate components such as a transmission or the like. The engine 16 may be designed to drive the rear when 12, the front wheels 14 or a combination thereof. The engine 16 may be, for example, a big twin engine, such as those used by two-wheeled motorcycles, such as the Harley-Davidson® Road Glide®. In some embodiments, the motorcycle 10 of the present invention could be designed by modifying an existing motorcycle, such as the Road Glide® by removing the front wheel, mounting the bike to two front wheels, and moving the engine forward to be disposed between the two front wheels. The advantages of such a design may allow aftermarket parts and accessories made available by Harley Davidson and other third party vendors to easily fit onto the motorcycle of the present invention.

While the motorcycle 10 of the present invention is a significant change and improvement on the conventional reverse trike, the cost for such a modification of a typical touring cycle (or the direct manufacture of the motorcycle 10) would require little, if any, additional cost. Rear wheel trike conversions, on the other hand, can cost upwards to $10,000 and can result in a bike that is unstable in turns.

In summary, the motorcycle of the present invention offers a rider a conventional motorcycle type ride by utilizing a straddle seat. Many reverse trike “motorcycles” on the market use bucket style seats, allowing two riders to sit, side-by-side. The motorcycle of the present invention provides a more typical ride, with the users straddling the seat and, with two riders, being positioned front-to-back. In addition, the motorcycle of the present invention has the engine forward of the passenger portion of the bike, typically between the front wheels. This design results in less engine heat radiating to the rider and allows additional space for the rider.

It should be understood, of course, that the foregoing relates to exemplary embodiments of the invention and that modifications may be made without departing from the spirit and scope of the invention as set forth in the following claims.

What is claimed is:

1. A reverse trike motorcycle comprising:
a rear wheel;
first and second front wheels;
an engine disposed between the first and second front wheels; and
a straddle-style seat disposed between the rear wheel and the first and second front wheels.

2. The reverse trike motorcycle of claim 1, wherein the engine is a longitudinal mount front engine.

3. The reverse trike motorcycle of claim 1, wherein a space is disposed between the seat and a steering column of the motorcycle.

4. The reverse trike motorcycle of claim 1, wherein the engine is disposed forward of the steering column of the reverse trike motorcycle.

5. A reverse trike motorcycle comprising:
a rear wheel;
first and second front wheels;
an engine disposed forward of a steering column of the reverse trike motorcycle; and
a straddle-style seat disposed between the rear wheel and the first and second front wheels.

6. The reverse trike motorcycle of claim 5, wherein the engine is a longitudinal mount front engine.

7. The reverse trike motorcycle of claim 5, wherein a space is disposed between the seat and a steering column of the motorcycle.

8. The reverse trike motorcycle of claim 1, wherein the engine is disposed between the first and second front wheels.

9. A reverse trike motorcycle comprising:
a rear wheel;
first and second front wheels;
a longitudinal mounted front engine disposed between the first and second front wheels;
a space is disposed between the seat and a steering column of the motorcycle; and
a straddle-style seat disposed between the rear wheel and the first and second front wheels.

10. The reverse trike motorcycle of claim 9, wherein the engine is disposed forward of the steering column of the reverse trike motorcycle.
